(19) United States
(12) Patent Application Publication
(10) Pub. No.: US 2013/0171891 A1
(43) Pub. Date: Jul. 4, 2013

(54) CONNECTION TERMINAL AND CIRCUIT COMPONENT

(71) Applicants: Junji Tsuruoka, Anjo-shi (JP); Seiji Yasui, Nagoya-shi (JP)

(72) Inventors: Junji Tsuruoka, Anjo-shi (JP); Seiji Yasui, Nagoya-shi (JP)

(73) Assignee: AISIN AW CO., LTD., Anjo-shi, Aichi-ken (JP)

(21) Appl. No.: 13/822,860

(22) PCT Filed: Nov. 15, 2011
(86) PCT No.: PCT/JP2011/076299

§ 371 Date: Mar. 13, 2013

(30) Foreign Application Priority Data
Nov. 15, 2010 (JP) 2010-254967

(51) Int. Cl. H01R 13/02

(52) U.S. Cl. CPC H01R 13/02
USPC 439/884

(57) ABSTRACT

A connection terminal that is conductive and that has a flat joint surface to be joined to a joint target surface by a brazing material interposed between the joint surface and the joint target surface. The joint surface has recesses provided on both sides across a predetermined reference line passing through a center of gravity of the joint surface and extending along the joint surface, and the recesses are dented from an outer edge portion of the joint surface toward the reference line.

### INCORPORATION BY REFERENCE

The disclosure of Japanese Patent Application No. 2010-254967 filed on Nov. 15, 2010 including the specification, drawings and abstract is incorporated herein by reference in its entirety.

### BACKGROUND OF THE INVENTION

The present invention relates to a connection terminal that is conductive and that has a flat joint surface to be joined to a joint target surface by a brazing material interposed between the joint surface and the joint target surface, and to a circuit component including the connection terminal.

### DESCRIPTION OF THE RELATED ART

An example of the connection terminal described above according to the related art is described in Japanese Patent Application Publication No. 2010-103222 (JP 2010-103222 A) (paragraph 0031, FIG. 1, etc.) mentioned below, for example. In the following description in the BACKGROUND ART section, reference numerals used in JP 2010-103222 A are used. FIG. 1 of JP 2010-103222 A shows a connection terminal (terminal blocks 62a and 62b) including a flat joint surface to be joined to a joint target surface (upper surface of an insulating substrate 20). The connection terminal includes three parts, specifically a joint portion including the joint surface to be joined to the insulating substrate 20, an upper portion provided above the joint portion, and a coupling portion that couples the joint portion and the upper portion to each other.

As described in paragraph 0031 of JP 2010-103222 A, the connection terminal is occasionally joined to the joint target surface by solder (an example of a brazing material). In the case where the connection terminal is joined to the joint target surface by the brazing material, it is desirable that the brazing material melted by heating should be spread over the entire joint surface, and that an excessive brazing material should not concentrate on a part of the joint surface. This is because the connection terminal may be tilted, for example, to reduce the reliability of joint between the connection terminal and the joint target surface in the case where the brazing material is not spread over the entire joint surface or in the case where an excessive brazing material concentrates on a part of the joint surface.

In order to address the issue described above, there is known a technology for supplying a brazing material to the entire joint surface and suppressing local concentration of an excessive brazing material by executing a process (scrubbing process) in which the connection terminal is swung in a plane parallel to the joint target surface with the brazing material fused. In order to execute the scrubbing process, it is necessary to provide a swing space for swinging the connection terminal in a joint region to which the connection terminal is to be joined. In order to suppress an increase in size of a circuit component including the connection terminal, it is desirable that the swing space should be reduced as much as possible.

However, JP 2010-103222 A does not mention the scrubbing process. Japanese Patent Application Publication No. 2005-228898 (JP 2005-228898 A) (FIG. 1 etc.) mentioned below describes a technology for forming a through hole in a joint portion in order to enhance the reliability of soldering (an example of brazing). However, JP 2005-228898 A does not mention the scrubbing process, either. Therefore, as a matter of course, none of JP 2010-103222 A and JP 2005-228898 A suggests a configuration of a connection terminal that is suitable from the viewpoint of reducing the swing space, and such a configuration has not been revealed yet.

### SUMMARY OF THE INVENTION

In view of the foregoing, it is desirable to provide a connection terminal having a configuration that is suitable from the viewpoint of reducing a swing space necessary to execute a scrubbing process.

A connection terminal according to a first aspect of the present invention is conductive and has a flat joint surface to be joined to a joint target surface by a brazing material interposed between the joint surface and the joint target surface. The joint surface includes recesses provided on both sides across a predetermined reference line passing through a center of gravity of the joint surface and extending along the joint surface, the recesses being dented from an outer edge portion of the joint surface toward the reference line.

According to the first aspect, the outer edge of the joint surface can be formed so as to have portions that intersect a line parallel to a direction parallel to the reference line (hereinafter referred to as “reference direction”) not only on both sides in the reference direction but also on both sides across the reference line, irrespective of the shape of the joint surface. Hence, in the case where a scrubbing process is executed, the brazing material can be appropriately spread by the outer edge portion of the joint surface not only on both sides in the reference direction but also on both sides across the reference line just by swinging the connection terminal in the reference direction. Consequently, it is possible to supply the brazing material to the entire joint surface, and to suppress local concentration of an excessive brazing material.

As described above, according to the first aspect, in the case where a scrubbing process is executed in order to appropriately secure the reliability of joint between the connection terminal and the joint target surface, it is only necessary to swing the connection terminal in the reference direction, that is, swing the connection terminal in one direction. That is, it is only necessary that the swing space necessary to execute a scrubbing process should be provided on the outer side with respect to the joint surface in the reference direction, thereby suppressing an increase in size of a circuit component including the connection terminal by reducing the swing space to be small.

The connection terminal may include: a joint portion that is flat and that includes the joint surface on a lower surface, and an extension portion provided to extend upward from a region of the outer edge portion of the joint portion, the region being interposed between the adjacent recesses.

The term “extend” in a certain direction as used herein for the shape of a member is not limited to extension of the member in a direction parallel to a reference direction defined by the certain direction, and also includes extension of the member in a direction intersecting the reference direction and even extension of the member in a direction intersecting the reference direction at an intersection angle of less than 90 degrees.

According to the configuration, the recesses are formed at positions of the outer edge portion of the joint surface at which the extension portion is not provided, thereby simplifying the manufacturing process of the connection terminal. In the configuration described above, meanwhile, the connection terminal may be easily tilted depending on the shape of the extension portion. However, such tilt of the connection terminal can be suppressed by executing a scrubbing process.

The recess provided on one side with respect to the reference line and the recess provided on the other side with respect to the reference line may be shaped to be symmetric with respect to the reference line.

According to the configuration, in the case where a scrubbing process is executed by swinging the connection terminal in the reference direction, the brazing material may be spread approximately equally on both sides across the reference line. Hence, in the case where a scrubbing process is executed, non-uniform application of the brazing material on both sides of the reference line may be suppressed to more reliably secure the reliability of joint between the connection terminal and the joint target surface.

A scooping portion may be formed at least a part of portions of the recesses that intersect a line parallel to the reference line, the scooping portion being projected toward a recess center along a direction parallel to the reference line as the recesses extend toward the joint surface.

According to the configuration, the scooping portion is formed on a surface of the recesses to allow the scooping portion to scoop up excessive solder in the scrubbing process discussed above. Therefore, the amount of excessive solder that overflows around the joint surface may be reduced to suppress an increase in size of a fillet.

If there is much excessive solder, and in the case where the center of gravity of the connection terminal is eccentric, the excessive solder provided on the side of the center of gravity of the connection terminal may easily overflow around the joint surface to tilt the connection terminal. According to the configuration described above, the amount of excessive solder may be reduced. Therefore, such tilt of the connection terminal may be suppressed even in the case where the center of gravity of the connection terminal is eccentric.

The recesses may be each formed such that a width of the recess in a direction parallel to the reference line becomes larger from a side of the reference line toward the outer edge portion of the joint surface.

According to the configuration, in the case where a scrubbing process is executed by swinging the connection terminal in the reference direction, it is possible to more reliably spread the brazing material as the recesses are swung. By appropriately setting the width of the recesses in the reference direction, in addition, formation of a fillet on both sides of the reference line may be suppressed, and a clearance provided on the outer side with respect to the joint region in a direction orthogonal to the reference direction may be reduced to be small.

A plated layer having wettability to the brazing material may be formed on a surface of the recesses.

According to the configuration, in the case where a scrubbing process is executed by swinging the connection terminal in the reference direction, it is possible to more reliably spread the brazing material as the recesses are swung.

A circuit component according to a second aspect of the present invention includes: the connection terminal configured as discussed above; and a substrate having an element arrangement surface serving as the joint target surface for arrangement of a circuit element. The connection terminal is joined in a joint region set on the element arrangement surface; and the joint region has a margin region in which the circuit element or the joint portion is not to be disposed and which is provided on an outer side of the joint surface along a reference direction which is a direction parallel to the reference line.

According to the second aspect, the connection terminal may be swung in the reference direction utilizing the margin region in the case where the connection terminal is joined on the substrate on which the circuit element is disposed. Therefore, the connection terminal having each configuration discussed above may be appropriately joined to the element arrangement surface through a scrubbing process.

### BRIEF DESCRIPTION OF THE DRAWINGS

FIG. 1 is a perspective view of a circuit component according to an embodiment of the present invention;

FIG. 2 shows regions formed on an element arrangement surface according to the embodiment of the present invention;

FIG. 3 is a bottom view of a connection terminal according to the embodiment of the present invention;

FIG. 4 is an enlarged view of the vicinity of a joint portion between a first connection terminal and a substrate according to the embodiment of the present invention;

FIG. 5 is a perspective view of a recess formed with scooping portions according to another embodiment of the present invention;

FIG. 6 is a sectional view of the recess formed with the scooping portions according to the other embodiment of the present invention;

FIG. 7 illustrates the effect of recesses formed with no scooping portions according to a comparative example of the other embodiment of the present invention;

FIG. 8 illustrates the effect of recesses formed with the scooping portions according to the other embodiment of the present invention;

FIG. 9 is a perspective view of a recess formed with a scooping portion according to still another embodiment of the present invention; and

FIG. 10 is a cross-sectional view of a recess formed with scooping portions according to yet another embodiment of the present invention.

### DETAILED DESCRIPTION OF THE EMBODIMENTS

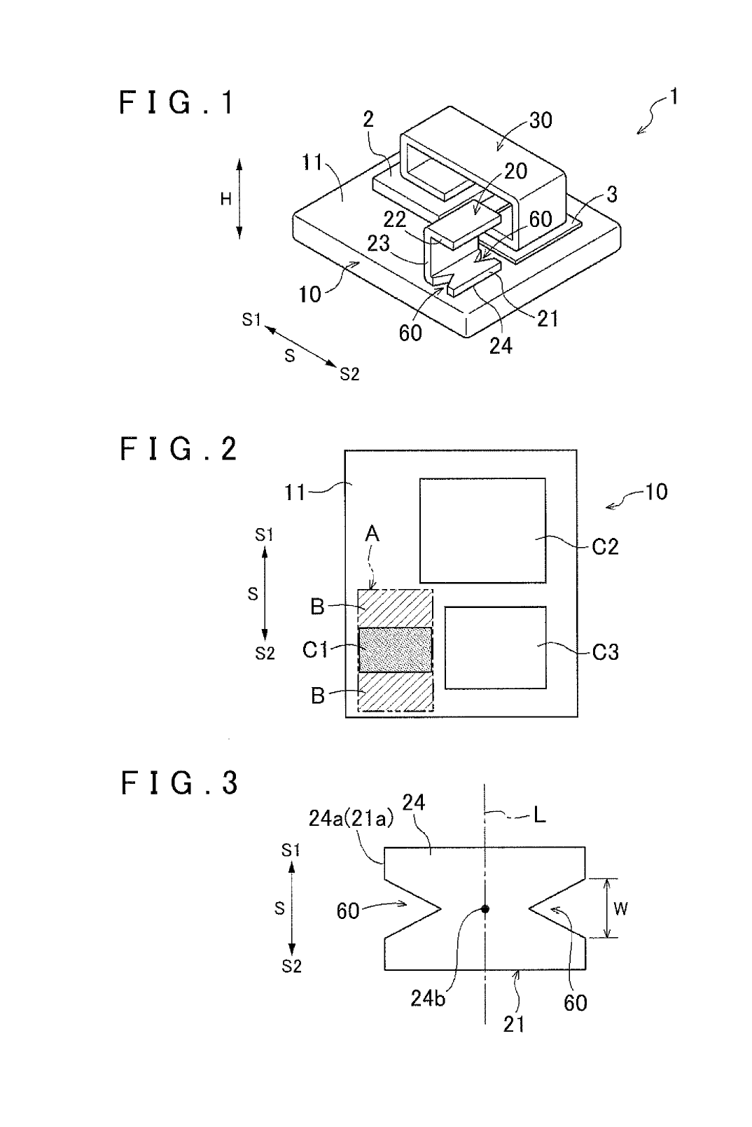

A connection terminal and a circuit component according to an embodiment of the present invention will be described with reference to the drawings. Here, the connection terminal according to the present invention is applied to a connection terminal for use in a semiconductor device (an example of an electrical circuit device) including a semiconductor device (an example of a circuit element), and the circuit component according to the present invention is a circuit component for a semiconductor device including the connection terminal, a semiconductor element, and a substrate. In a circuit component 1 according to the embodiment, as shown in FIG. 1, a first connection terminal 20 for connection between circuit elements (a switching element 2 and a diode element 3) disposed on an element arrangement surface 11 of a substrate 10 and a connection member (not shown) is joined in a joint region A (see FIG. 2) formed on the element arrangement surface 11. In such a configuration, the circuit component 1 according to the embodiment is characterized in the configuration of the first connection terminal 20 and the configuration of the joint region A for the arrangement of the first connection terminal 20. The “Overall Configuration of Circuit Component” and “Configuration of First Connection Terminal” will be described in this order below.

In the following description, the term “upper” denotes a direction (+H direction, which corresponds to the upper direction in FIG. 1) in which the height becomes larger along a height direction H (a direction orthogonal to a joint surface 24), and the term “lower” denotes a direction (−H direction, which corresponds to the lower direction in FIG. 1) in which the height becomes smaller along the height direction H. As shown in FIG. 3, in addition, a predetermined line passing through a center of gravity 24b of the joint surface 24 and extending along the joint surface 24 is defined as a reference line L, and a direction parallel to the reference line L is defined as a reference direction S. The term “first reference direction S1” denotes the leftward and upward direction along the reference direction S in FIG. 1, and the term “second reference direction S2” denotes the rightward and downward direction along the reference direction S in FIG. 1.

### 1. Overall Configuration of Circuit Component

The overall configuration of the circuit component will be described with reference to FIG. 1. As shown in FIG. 1, the circuit component 1 includes the switching element 2, the diode element 3, the first connection terminal 20, a second connection terminal 30, and the substrate 10. The upper surface of the substrate 10 serves as the element arrangement surface 11 for the arrangement of the switching element 2 and the diode element 3. In the example, the substrate 10 is formed from a conductive material (for example, a metal material such as copper or aluminum), and the substrate 10 also functions as a heat spreader.

The switching element 2 and the diode element 3 serving as circuit elements are disposed on the element arrangement surface 11. In the example, the switching element 2 and the diode element 3 are disposed side by side in the reference direction S. That is, the direction of arrangement of the circuit elements (in the example, the switching element 2 and the diode element 3) on the element arrangement surface 11 coincides with the reference direction S. The switching element 2 includes an emitter electrode on the upper surface and a collector electrode on the lower surface. The switching element 2 is fixed to the element arrangement surface 11 by solder to bring the collector electrode on the lower surface into continuity with the substrate 10. The diode element 3 includes an anode electrode on the upper surface and a cathode electrode on the lower surface. The diode element 3 is fixed to the element arrangement surface 11 by solder to bring the cathode electrode on the lower surface into continuity with the substrate 10. That is, the substrate 10 is at the same potential as the collector electrode of the switching element 2 and the cathode electrode of the diode element 3. In the embodiment, both the switching element 2 and the diode element 3 correspond to the “circuit element” according to the present invention. That is, in the embodiment, the circuit element is a semiconductor element (electronic element).

The circuit component 1 according to the embodiment is a circuit component that forms a semiconductor device (not shown) including an inverter circuit that controls a rotary electric machine (not shown). The semiconductor device includes a plurality of (in the example, six) circuit components 1 shown in FIG. 1, and a bridge circuit that forms the inverter circuit is formed from a total of six switching elements 2 provided in the six circuit components 1. The switching elements 2 and the rotary electric machine and a power source (not shown) are electrically connected via a connection member (not shown) such as a bus bar. Each of six diode elements 3 is connected in parallel between the emitter and the collector of the switching element 2 to function as an FWD (Free Wheel Diode). The rotary electric machine to be controlled by the semiconductor device is a three-phase AC electric motor (motor generator) provided as a drive power source in an electric vehicle or a hybrid vehicle, for example.

In order to electrically connect the switching element 2 and the diode element 3 and the connection member, the circuit component 1 includes the first connection terminal 20 and the second connection terminal 30. Both the first connection terminal 20 and the second connection terminal 30 are formed from a conductive material (for example, a metal material such as copper or aluminum). In the example, both the first connection terminal 20 and the second connection terminal 30 are formed by bending a belt-like member (plate-like member) with a constant width.

The first connection terminal 20 is fixed by solder on the element arrangement surface 11 of the substrate 10. The first connection terminal 20 is brought into continuity with the lower surface (collector electrode) of the switching element and the lower surface (cathode electrode) of the diode element 3 via the substrate 10 formed from a conductive material. The upper surface of the first connection terminal 20 forms a joint surface to be joined (for example, joined by laser welding) to the connection member. In the embodiment, the first connection terminal 20 has been subjected to a scrubbing process executed when joining the first connection terminal 20 to the element arrangement surface 11 by solder. The configuration of the first connection terminal 20 will be described in detail later in Section 2. In the embodiment, the first connection terminal 20 corresponds to the “connection terminal” according to the present invention. In the embodiment, the element arrangement surface 11 corresponds to the “joint target surface” according to the present invention.

The second connection terminal 30 is fixed to the upper surfaces of the semiconductor elements (the switching element 2 and the diode element 3) by solder. That is, in the example, the second connection terminal 30 is disposed on the substrate 10 with the semiconductor elements (circuit elements) interposed therebetween. As shown in FIG. 1, the second connection terminal 30 is disposed to electrically connect between the upper surface (emitter electrode) of the switching element 2 and the upper surface (anode electrode) of the diode element 3. The upper surface of the second connection terminal 30 forms a joint surface to be joined (for example, joined by laser welding) to the connection member.

### 2. Configuration of First Connection Terminal

Next, the configuration of the first connection terminal 20 will be described in detail. As shown in FIG. 1, the first connection terminal 20 includes a first joint portion 21, a second joint portion 22, and a coupling portion 23 that couples the first joint portion 21 and the second joint portion 22 to each other. In the example, as described above, the first connection terminal 20 is formed by bending a belt-like member (plate-like member) with a constant width. Hence, each of the various portions (the first joint portion 21, the second joint portion 22, and the coupling portion 23) of the first connection terminal 20 is formed to be flat.

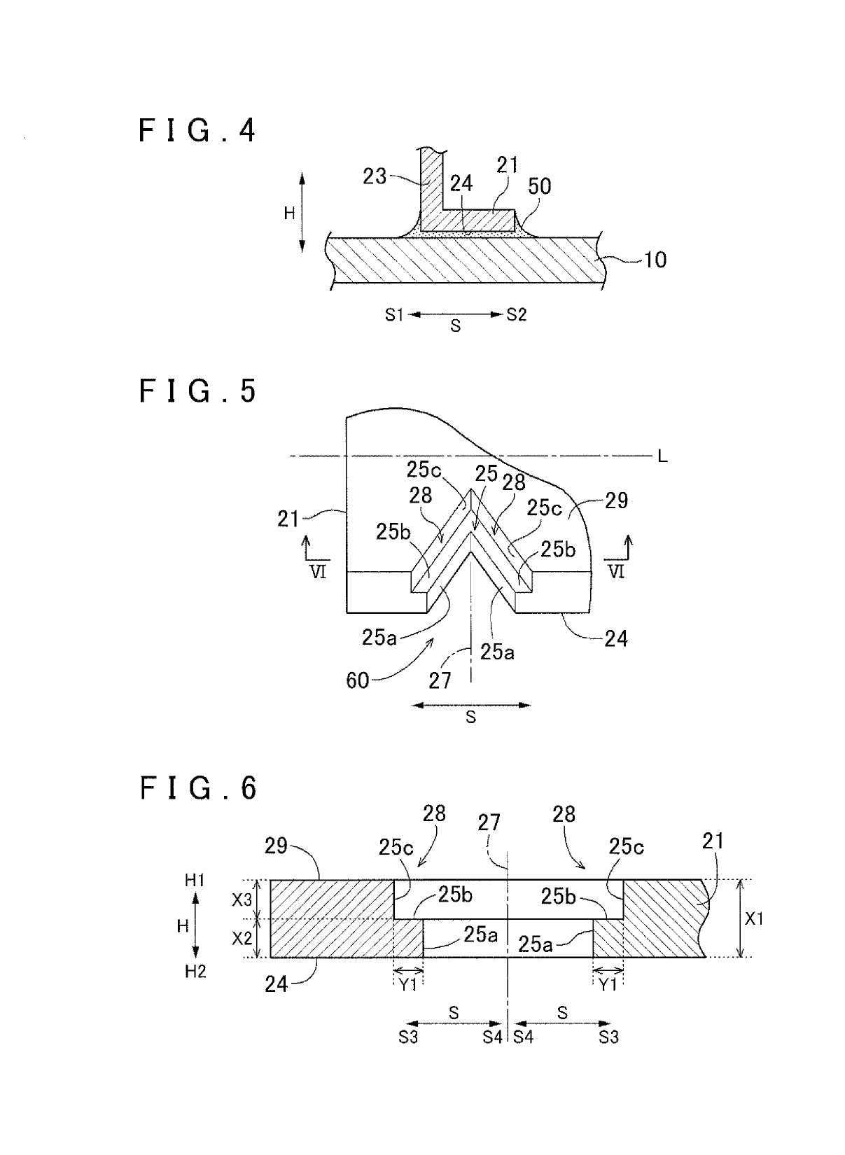

The first joint portion 21 is a portion to be joined to the element arrangement surface 11. The lower surface of the first joint portion 21 serves as the flat joint surface 24 to be joined to the element arrangement surface 11. In the example, as shown in FIG. 4, the joint surface 24 and the element arrangement surface 11 are joined by solder 50. That is, the first connection terminal 20 includes the joint surface 24 to be joined to the element arrangement surface 11 by the solder 50 interposed between the joint surface 24 and the element arrangement surface 11. The joint surface 24 is disposed in parallel with the element arrangement surface 24. Therefore, the height direction H, which is orthogonal to the joint surface 24, is also orthogonal to the element arrangement surface 11. In the embodiment, the first joint portion 21 corresponds to the “joint portion” according to the present invention. In the embodiment, in addition, the solder 50 corresponds to the “brazing material” according to the present invention. In the present invention, a variety of types of solder may be adopted irrespective of the type of metal (such as tin, for example) contained as a main component.

The second joint portion 22 is a portion, on the upper surface of which a joint surface to be joined to the connection member is formed. The second joint portion 22 is provided apart from the first joint portion 21 in the height direction H. In the example, the first joint portion 21 and the second joint portion 22 are disposed in parallel with each other. In the embodiment, in addition, the first joint portion 21 and the second joint portion 22 are formed to have a rectangular shape of the same size, and disposed so as to overlap each other as seen along the height direction H. More specifically, in the embodiment, the first joint portion 21 and the second joint portion 22 are disposed such that one of the first joint portion 21 and the second joint portion 22 is hidden behind the other, except for portions that are viewable through recesses 60 to be discussed later, in the case where the first joint portion 21 and the second joint portion 22 are seen from either side along the height direction H. The first joint portion 21 and the second joint portion 22 may be formed to have a rectangular shape of different sizes.

In the example, the coupling portion 23 couples respective end portions, in the reference direction S, of the first joint portion 21 and the second joint portion 22 to each other. In the example, further, the coupling portion 23 couples respective end portions, which are on the same side in the reference direction S (in the example shown in FIG. 1, respective end portions on the first reference direction S1 side), of the first joint portion 21 and the second joint portion 22 to each other. In the embodiment, as described above, the first joint portion 21 and the second joint portion 22 are formed to have a rectangular shape of the same size, and the coupling portion 23 is formed to extend along the height direction H. Consequently, the section of the first connection terminal 20 in a place including both the height direction H and the reference direction S has an angular U shape. In the embodiment, the coupling portion 23 corresponds to the “extension portion” according to the present invention.

As shown in FIGS. 1 and 3, the joint surface 24 includes the recesses 60 which are provided on both sides across the reference line L and which are dented from an outer edge portion 24a of the joint surface 24 toward the reference line L, the reference line L being a predetermined line passing through the center of gravity 24b of the joint surface 24 and extending along the joint surface 24. In the example, as shown in FIG. 3, the joint surface 24 would be formed in a rectangular shape without the recesses 60, and therefore the center of gravity 24b of the joint surface 24 is located at the intersection of the diagonal lines of the rectangular shape. The shape of the joint surface 24 may be circular, polygonal, or the like rather than rectangular.

By providing such recesses 60, the outer edge of the joint surface 24 is formed so as to have portions that intersect a line parallel to the reference direction S not only on both sides in the reference direction S but also on both sides across the reference line L as shown in FIG. 3. Hence, in the case where a scrubbing process is executed when joining the first connection terminal 20 and the element arrangement surface 11 to each other, the solder 50 can be appropriately spread by portions of the outer edge portion 24a that correspond to the recesses 60 of the joint surface 24 not only on both sides in the reference direction S but also on both sides across the reference line L just by swinging the first connection terminal 20 in the reference direction S. That is, it is only necessary that the swing space necessary to execute a scrubbing process should be provided at least on the outer side in the reference direction S with respect to the joint surface 24, thereby suppressing an increase in size of the circuit component 1 by reducing the swing space to be small.

In the example, the joint surface 24 includes one recess 60 provided on each of both sides across the reference line L, and includes a total of two recesses 60. The coupling portion 23 is provided to extend upward (in the +H direction) (in the example, along the height direction H) from a region of the outer edge portion 21a of the first joint portion 21 that is interposed between the adjacent recesses 60.

In the embodiment, as shown in FIG. 3, the recesses 60 are each formed such that the width W of the recess 60 in a direction (reference direction S) parallel to the reference line L becomes larger from the reference line L toward the outer edge portion 24a of the joint surface 24. Specifically, the recesses 60 are each formed as a notch having a triangular (V-shaped) cross section. Here, the cross section means a cross section taken along a plane orthogonal to the height direction H (plane parallel to the joint surface 24). That is, the recesses 60 are each shaped by cutting a part of the outer edge portion 24a of the joint surface 24 in a triangular shape (V shape) as viewed in plan (as viewed in a direction along the height direction H).

In the embodiment, in addition, as shown in FIG. 3, the recesses 60 are each formed at the intersection between a line passing through the center of gravity 24b of the joint surface 24 and orthogonal to the reference line L and the outer edge portion 24a of the joint surface 24 as seen along the height direction H. In the example, each of the recesses 60 is formed to be symmetric with respect to the line orthogonal to the reference line L as seen along the height direction H. That is, in the example, the recesses 60 are each formed as a notch having an isosceles triangular cross-sectional shape.

In the embodiment, further, as shown in FIG. 3, the recesses 60 are formed such that the recess 60 provided on one side with respect to the reference line L and the recess 60 provided on the other side with respect to the reference line L are symmetric with respect to the reference line L as seen along the height direction H. Consequently, in the case where a scrubbing process is executed when joining the first connection terminal 20 and the element arrangement surface 11 to each other, the solder 50 can be spread approximately equally on both sides across the reference line L, thereby suppressing non-uniform application of the solder 50 on both sides of the reference line L.

The first connection terminal 20 configured as described above is joined in the joint region A set on the element arrangement surface 11. As shown in FIG. 2, a switching element arrangement region C2 in which the switching element 2 is to be disposed and a diode element arrangement region C3 in which the diode element 3 is to be disposed are set on the element arrangement surface 11 in addition to the joint region A. The joint region A is provided adjacent to the switching element arrangement region C2 and the diode element arrangement region C3. Specifically, the joint region A is provided adjacent to the arrangement regions C2 and C3 for the circuit elements generally in a direction orthogonal to the direction of arrangement of the circuit elements (in the example, the reference direction S).

The joint region A has a joint surface arrangement region C1 in which the joint surface 24 is to be disposed, and a margin region B positioned on the outer side (in the example, both outer sides) of the joint surface arrangement region C1 in the reference direction S. Here, the margin region B means a region in which a circuit element (in the example, the switching element 2 and the diode element 3) or the joint surface 24 is not to be disposed. That is, in the example, the joint region A has the margin region B in which a circuit element or the joint surface 24 is not to be disposed and which is provided on the outer side (in the example, both outer sides) of the joint surface 24 along the reference direction S.

The joint surface arrangement region C1 has the same size as the joint surface 24. The length of each of the margin regions B in a direction orthogonal to the reference direction S is equal to or more than (in the example, the same as) the length of the joint surface 24 in the same direction. The length of each of the margin regions B in the reference direction S is preferably equal to or more than half of the length of the joint surface 24 in the reference direction S, and more preferably equal to or more than the length of the joint surface 24 in the reference direction S. In the example shown in FIG. 2, the length of each of the margin regions B in the reference direction S is set to be slightly shorter than the length of the joint surface 24 in the reference direction S.

Here, as described above, in the case where a scrubbing process is executed when joining the first connection terminal 20 and the element arrangement surface 11 to each other, the solder 50 can be appropriately spread by portions of the outer edge portion 24a that correspond to the recesses 60 of the joint surface 24 not only on both sides in the reference direction S but also on both sides across the reference line L just by swinging the first connection terminal 20 in the reference direction S. That is, in the case where a scrubbing process is executed when joining the first connection terminal 20 and the element arrangement surface 11 to each other, it is only necessary that the first connection terminal 20 should be swung in a direction along the reference direction S. Hence, even in a configuration in which the joint region A does not have a region that is large enough to allow the first connection terminal 20 to swing on the outer side of the joint surface 24 along a direction orthogonal to the reference direction S as in the example, it is possible to appropriately execute a scrubbing process utilizing the margin region B on the outer side in the reference direction S to supply solder to the entire joint surface 24 and suppress concentration of excessive solder on a part of the joint surface 24. Thus, according to the present invention, it is possible to appropriately secure the reliability of joint between the first connection terminal 20 and the element arrangement surface 11 while suppressing an increase in size of the circuit component 1 by reducing the swing space necessary for a scrubbing process to be small.

In the embodiment, in addition, a plated layer having wettability to solder (solder wettability) is formed on a surface of the recesses 60. The term “surface of the recesses 60” is used to include a surface extending in the +H direction (upward in the height direction H) from a portion of the outer edge portion 24a of the joint surface 24 corresponding to the recesses 60. The plated layer is formed from metal such as gold or nickel, for example. Consequently, in the case where a scrubbing process is executed by swinging the first connection terminal 20 in the reference direction S, it is possible to more reliably spread the solder 50 as the recesses 60 are swung. A plated layer having solder wettability may also be formed on surfaces of other portions of the first connection terminal 20 (for example, the lower surface of the first joint portion 21 and the upper surface of the second joint portion 22) in addition to the surface of the recesses 60, or a plated layer having solder wettability may be formed on the entire surface of the first connection terminal 20.

### 3. Other Embodiments

Lastly, other embodiments of the present invention will be described. The characteristics disclosed in each of the following embodiments are not only applicable to that particular embodiment but also to any other embodiment unless any contradiction occurs.
(1) In the embodiment described above, the recesses 60 are each formed as a notch having a triangular (V-shaped) cross section. However, the present invention is not limited thereto. The recesses 60 may each be formed as a notch having a semi-circular cross section or a notch having a rectangular cross section, for example.
(2) In the embodiment described above, the first connection terminal 20 includes a joint portion (first joint portion 21) and an extension portion (coupling portion 23). However, the first connection terminal 20 may be shaped as desired. For example, the first connection terminal 20 may include only a joint portion formed in a circular column shape or a rectangular column shape. In this case, the recesses 60 may be formed over the entirety of the joint portion in the height direction H, or the recesses 60 may be formed only at a lower portion of the joint portion in the height direction H.
(3) In the embodiment described above, the joint region A has the margin region B on both outer sides of the joint surface 24 along the reference direction S. However, the joint region A may have the margin region B only on one side of the joint surface 24 along the reference direction S. In this case, the length of the margin region B in the reference direction S is preferably set to be equal to or more than the length of the joint surface 24 in the reference direction S.
(4) In the embodiment described above, the recess 60 provided on one side with respect to the reference line L and the recess 60 provided on the other side with respect to the reference line L are symmetric with respect to the reference line L. However, the recesses 60 may be asymmetric with respect to the reference line L.
(5) In the embodiment described above, the recesses 60 are each formed such that the width W of the recess 60 in the reference direction S becomes larger from the reference line L toward the outer edge portion 24a of the joint surface 24. However, the present invention is not limited thereto. The recesses 60 may be each formed such that the width W of the recess 60 in the reference direction S is constant, or such that the width of the recess 60 in the reference direction S becomes smaller from the reference line L toward the outer edge portion 24a of the joint surface 24.
(6) In the embodiment described above, a surface 25 of the recesses 60 that intersects a line parallel to the reference line L is formed as a surface extending in a direction orthogonal to the joint surface 24. However, the present invention is not limited thereto. That is, as shown in FIG. 5, a scooping portion 28 projected toward a recess center 27 along a direction parallel to the reference line L, as the surface 25 extends toward the joint surface 24, may be formed at least a part of the surface 25 of the recesses 60, which is a portion of the recesses 60 that intersects a line parallel to the reference line L. Put the other way around, the surfaces 25 of the scooping portions 28 of the recesses 60 may be formed to be projected to the side opposite to the recess center 27 along a direction parallel to the reference line L, as the surfaces 25 extend away from the joint surface 24. With the scooping portion 28 formed at the recesses 60, excessive solder can be easily scooped up by the recesses 60 so that the excessive solder does not easily overflow around the joint surface 24 in a scrubbing process as discussed later.

In the example shown in FIG. 5, the scooping portion 28 is formed over the entire surface 25 of the recesses 60. In the example shown in FIG. 5, in addition, as shown in FIG. 6 which shows a sectional view of the first joint portion 21 taken in a plane parallel to the reference line L and orthogonal to the joint surface 24, the surface 25 of the scooping portion 28 of the recesses 60 is formed to be projected toward the recess center 27 along a direction parallel to the reference line L in the manner of a staircase of two steps as the surface 25 extends toward the joint surface 24.

In the following description, in the height direction H which is a direction orthogonal to the joint surface 24, a direction from the joint surface 24 toward a non-joint surface 29 which is a surface opposite to the joint surface 24 is set to a first height direction H1, and a direction opposite to the first height direction H1 from the non-joint surface 29 toward the joint surface 24 is set to a second height direction H2. In addition, in the reference direction S which is a direction parallel to the reference line L, a direction away from the recess center 27 is set to a separating reference direction S3, and a direction toward the recess center 27 is set to an approaching reference direction S4.

The surface 25 of the scooping portion 28 of the recesses 60 includes a first-step orthogonal surface 25a that extends in the first height direction H1 from the joint surface 24 and that has a height X2 smaller than a height X1 of the first joint portion 21, a solder holding surface 25b that extends by a width Y1 in the separating reference direction S3 from an end portion of the first-step orthogonal surface 25a in the first height direction H1, and a second-step orthogonal surface 25c that extends in the first height direction H1 from an end portion of the solder holding surface 25b in the separating reference direction S3 and that has a height H3 smaller than the height X1 of the first joint portion 21. Here, the total of the height X2 of the first-step orthogonal surface 25a and the height X3 of the second-step orthogonal surface 25c matches the height X1 of the first joint portion 21.

The first-step orthogonal surface 25a has a function of spreading the solder 50 toward both sides across the reference line L through a scrubbing process. The solder holding surface 25b and the second-step orthogonal surface 25c have a function of holding an excessive portion of the solder 50. If the height X2 of the first-step orthogonal surface 25a is reduced, the function of spreading the solder 50 is degraded, and excessive solder is easily scooped up by the solder holding surface 25b. If the height X2 of the first-step orthogonal surface 25a is increased, conversely, the function of spreading the solder 50 is improved, and excessive solder is not easily scooped up by the solder holding surface 25b. Meanwhile, if the width Y1 of the solder holding surface 25b is increased, an increased amount of excessive solder may be scooped up to be held. If the width Y1 of the solder holding surface 25b is reduced, conversely, a reduced amount of excessive solder may be scooped up to be held. Hence, the function of spreading the solder 50 and the function of holding excessive solder may be adjusted by adjusting the height X2 of the first-step orthogonal surface 25a and the width Y1 of the solder holding surface 25b.

A portion (first-step orthogonal surface 25a) of the scooping portion 28 on the joint surface 24 side projects toward the recess center 27 (in the approaching reference direction S4) along the reference direction 5, which is the swinging direction, with respect to a portion (second-step orthogonal surface 25c) of the scooping portion 28 on the non-joint surface 29 side. Therefore, the scooping portion 28 is shaped so as to easily scoop up the solder 50 by being swung in the reference direction S.

A plated layer having solder wettability is formed on the solder holding surfaces 25b so that excessive solder is easily held thereon. A plated layer having solder wettability is also formed on the first-step orthogonal surfaces 25a and the second-step orthogonal surfaces 25e.

<Function and Effect of Scooping Portions 28>

Next, the function and the effect of the scooping portions 28 will be described in detail.

If an excessive portion of the solder 50 is increased, an increased amount of the solder 50 overflows around the joint surface 24, which may increase the size of a fillet 41 of the solder 50 to be formed around the joint surface 24. If the fillet 41 becomes large, the fillet 41 may be unintentionally joined to components disposed around the joint surface 24 such as the switching element 2 and the diode element 3, which may reduce the reliability of soldering. By forming the scooping portion 28 on the surface 25 of the recesses 60, in contrast, excessive solder may be scooped up and held by the scooping portion 28, which makes it possible to control excessive solder such that the fillet does not become too large.

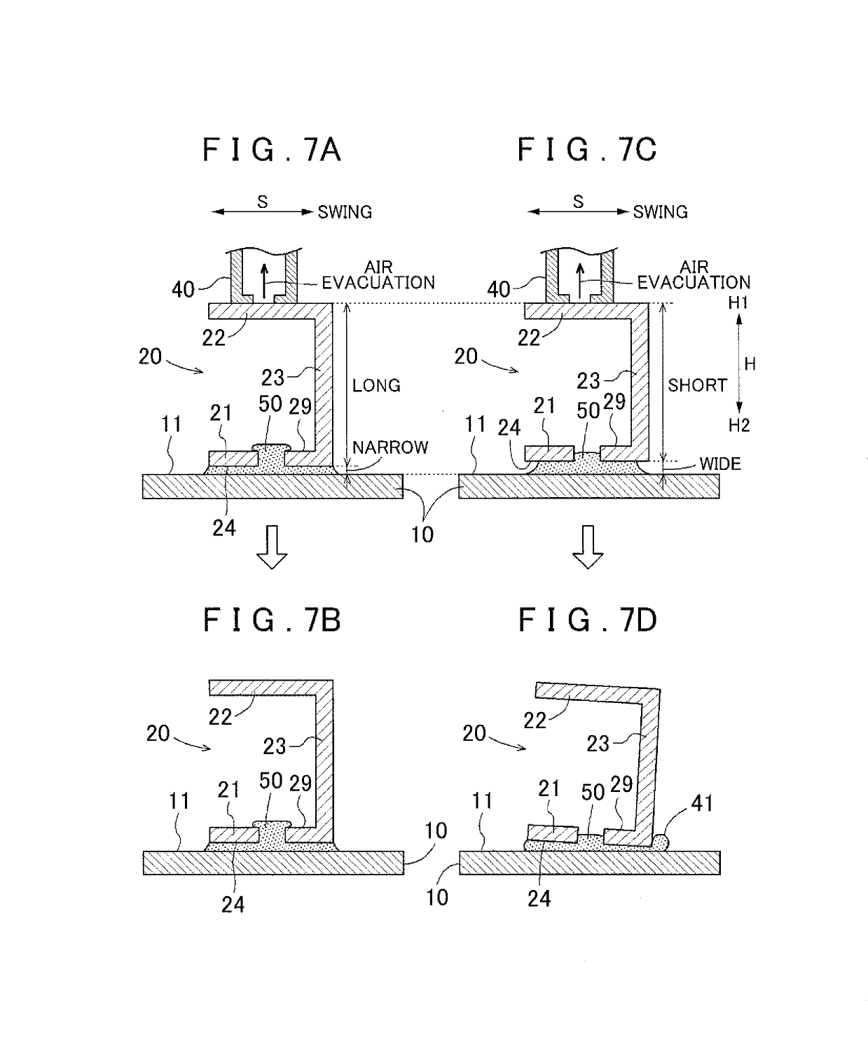

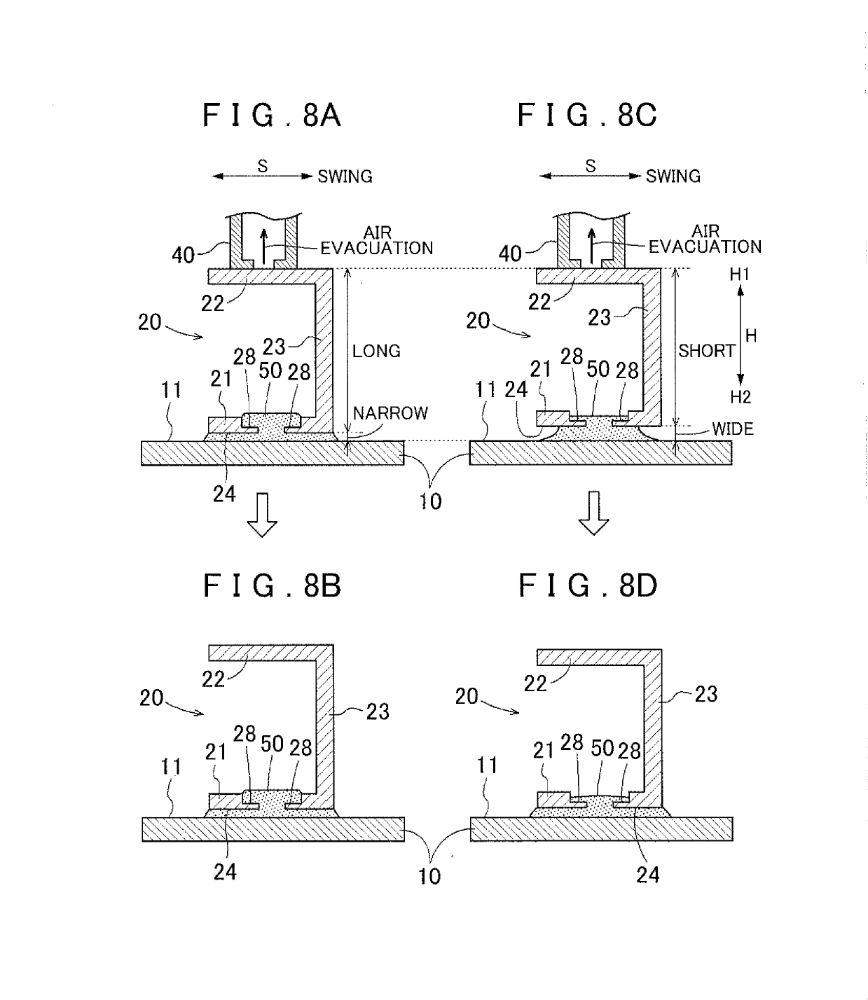

For example, in the case where the first connection terminal 20 is swung in a scrubbing process by holding the second joint portion 22 of the first connection terminal 20 using a holder 40 and swinging the holder 40 as shown in FIGS. 7 and 8, variations in length of the coupling portion 23 in the height direction H due to manufacturing variability result in variations in spacing between the joint surface 24 and the element arrangement surface 11 during swing of the first connection terminal 20. In the example shown in FIGS. 7 and 8, the holder 40 is configured to hold a surface of the second joint portion 22 on the side in the first height direction H1 using an air evacuation force.

FIG. 7 shows an example for a case where the scooping portions 28 are not formed at the recesses 60, and FIG. 8 shows an example for a case where the scooping portions 28 are formed at the recesses 60.

<Case where Scooping Portions 28 are not Formed>

First, a case where the scooping portions 28 are not formed will be described with reference to FIG. 7.

As shown in FIG. 7A, in the case where the length of the coupling portion 23 is large because of manufacturing variability, the spacing between the joint surface 24 and the element arrangement surface 11 during swing is small. Since the spacing between the joint surface 24 and the element arrangement surface 11 is small, a reduced amount of solder can be held in the space between the joint surface 24 and the element arrangement surface 11 during swing, and an increased amount of solder overflows from the space into the recesses 60 because of the swing. Therefore, excessive solder passes from the joint surface 24 through the recesses 60 to overflow to the side of the non-joint surface 29, and the excessive solder is held by the non-joint surface 29. Then, as shown in FIG. 7B, even when the holder 40 is removed from the first connection terminal 20 after a scrubbing process, the excessive solder does not overflow around the joint surface 24 to increase the size of the fillet 41 since the excessive solder is held by the non-joint surface 29.

As shown in FIG. 7C, in the case where the length of the coupling portion 23 is small because of manufacturing variability, on the other hand, the spacing between the joint surface 24 and the element arrangement surface 11 during swing is large. Since the spacing between the joint surface 24 and the element arrangement surface 11 is large, an increased amount of solder can be held in the space between the joint surface 24 and the element arrangement surface 11 during swing, and a reduced amount of solder overflows from the space into the recesses 60 because of the swing. Therefore, excessive solder does not pass from the joint surface 24 through the recesses 60 to overflow to the side of the non-joint surface 29 during the swing, and the excessive solder remains held in the space between the joint surface 24 and the element arrangement surface 11. Then, as shown in FIG. 7D, when the holder 40 is removed from the first connection terminal 20 after a scrubbing process, the space between the joint surface 24 and the element arrangement surface 11 is reduced by the own weight of the first connection terminal 20, and the excessive solder overflows around the joint surface 24 to increase the size of the fillet 41. In this event, the first connection terminal 20 may be tilted if the center of gravity of the first connection terminal 20 is eccentric as shown in FIG. 7C.

<Case where Scooping Portions 28 are Formed>

Next, a case where the scooping portions 28 are formed will be described with reference to FIG. 8.

As shown in FIG. 8A, in the case where the length of the coupling portion 23 is large as in FIG. 7A, excessive solder overflows from the joint surface 24 to the scooping portions 28 of the recesses 60 to be held by the scooping portions 28. Then, as shown in FIG. 8B, even when the holder 40 is removed after a scrubbing process, the excessive solder does not overflow around the joint surface 24 to increase the size of the fillet 41 as in FIG. 7B since the excessive solder is held by the scooping portions 28.

As shown in FIG. 8C, in the case where the length of the coupling portion 23 is short as in FIG. 7C, on the other hand, excessive solder is held by the scooping portions 28 since the solder 50 has been scooped up by the scooping portions 28 to be easily held, even if a reduced amount of solder overflows into the recesses 60 because of the swing. In the example shown in FIG. 8, the scooping portions 28 are formed in the manner of a staircase of two steps, and the height X2 of the first-step orthogonal surface 25a is smaller than the height X1 of the first joint portion 21. Thus, solder having overflowed into the recesses 60 may easily go beyond the first-step orthogonal surface 25a to reach the solder holding surface 25b. In addition, the amount of excessive solder to be held by the solder holding surface 25b may be adjusted by adjusting the width Y1 of the solder holding surface 25b. Then, as shown in FIG. 8D, even when the holder 40 is removed after a scrubbing process and the space between the joint surface 24 and the element arrangement surface 11 is reduced by the own weight of the first connection terminal 20, the amount of solder that overflows around the joint surface 24 may be reduced to suppress an increase in size of the fillet 41 since the excessive solder has been held by the scooping portions 28 in advance. Moreover, tilt of the first connection terminal 20 may be suppressed even in the case where the center of gravity of the first connection terminal 20 is eccentric.

The height X2 of the first-step orthogonal surface 25a and the width Y1 of the solder holding surface 25b may be adjusted in consideration of variations (tolerance) in length of the coupling portion 23 due to manufacturing variability.

<Variations of Scooping Portions 28>

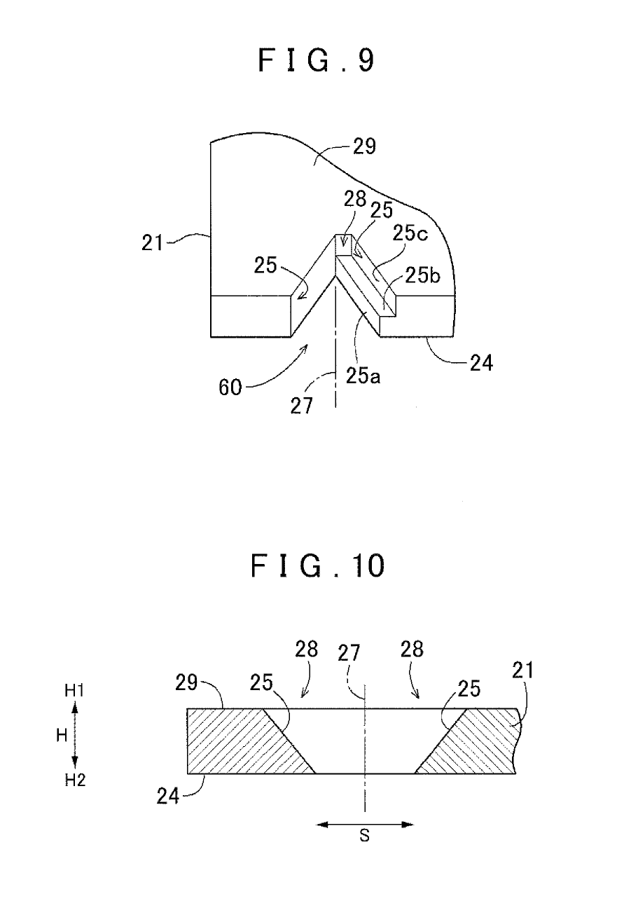

The scooping portion 28 may be formed on a part of the surface 25 of the recesses 60. For example, as shown in the example of FIG. 9, the scooping portion 28 may be formed only on the surface 25 on one side with respect to the recess center 27.

As shown in the cross-sectional view of FIG. 10 which is similar to FIG. 6, besides, the surface 25 of the scooping portion 28 of the recesses 60 may be an inclined surface formed to be gradually projected toward the recess center 27 along a direction parallel to the reference line L as the surface 25 extends toward the joint surface 24. Alternatively, the surface 25 of the scooping portion 28 may be formed as a combination of an inclined surface and stair-like steps.
(7) In the embodiment described above, a plated layer having solder wettability is formed on the surface of the recesses 60. However, such a plated layer may not be formed depending on the material of the first connection terminal 20.
(8) In the embodiment described above, the joint surface 24 includes one recess 60 provided on each of both sides across the reference line L. However, the present invention is not limited thereto. The joint surface 24 may include N recesses 60 (N is an integer of 2 or more) provided on each of both sides across the reference line L. Besides, different numbers of recesses 60 may be formed on both sides across the reference line L.
(9) In the embodiment described above, the coupling portion 23 couples respective end portions, which are on the same side in the reference direction S, of the first joint portion 21 and the second joint portion 22 to each other. However, the present invention is not limited thereto. The coupling portion 23 may couple respective end portions, which are on different sides in the reference direction S, of the first joint portion 21 and the second joint portion 22 to each other. In such a configuration, the coupling portion 23 may be formed to extend uniformly along a direction inclined with respect to and intersecting the height direction H, or the coupling portion 23 may have a single or a plurality of (for example, two) bent portions provided at an intermediate portion thereof.
(10) In the embodiment described above, the first connection terminal 20 is joined to the element arrangement surface 11. However, the first connection terminal 20 may be joined to the upper surface of a circuit element (for example, the switching element 2 or the diode element 3) disposed on the element arrangement surface 11. That is, the joint target surface may be a surface (upper surface) of a circuit element in place of the element arrangement surface 11 of the substrate 10.
(11) In the embodiment described above, the brazing material according to the present invention is solder. However, the present invention is not limited thereto. A variety of brazing materials (which may include gold, silver, and copper, for example, and which may be either hard solder or soft solder) that have a melting point lower than that of the connection terminal (first connection terminal 20) and the joint target surface (element arrangement surface 11) can be adopted. Further, the brazing material is not limited to a material made from an alloy, and any conductive material that can be liquefied by heating and solidified by cooling (including natural cooling) to join the connection terminal and the joint target surface to each other may be adopted as the brazing material.
(12) Also regarding other configurations, the embodiment disclosed herein is illustrative in all respects, and the present invention is not limited thereto. That is, it is a matter of course that a configuration obtained by appropriately altering part of a configuration not disclosed in the claims of the present invention also falls within the technical scope of the present invention as long as the resulting configuration includes a configuration disclosed in the claims or a configuration equivalent thereto.

The present invention may be suitably applied to a connection terminal that is conductive and that has a flat joint surface to be joined to a joint target surface by a brazing material interposed between the joint surface and the joint target surface.

1. A connection terminal that is conductive and that has a flat joint surface to be joined to a joint target surface by a brazing material interposed between the joint surface and the joint target surface, wherein
the joint surface has recesses provided on both sides across a predetermined reference line passing through a center of gravity of the joint surface and extending along the joint surface, the recesses being dented from an outer edge portion of the joint surface toward the reference line.

2. The connection terminal according to claim 1, comprising:
a joint portion that is flat and that includes the joint surface on a lower surface, and
an extension portion provided to extend upward from a region of the outer edge portion of the joint portion, the region being interposed between the adjacent recesses.

3. The connection terminal according to claim 1, wherein
the recess provided on one side with respect to the reference line and the recess provided on the other side with respect to the reference line are shaped to be symmetric with respect to the reference line.

4. The connection terminal according to claim 1, wherein
a scooping portion is formed at least a part of portions of the recesses that intersect a line parallel to the reference line, the scooping portion being projected toward a recess center along a direction parallel to the reference line as the recesses extend toward the joint surface.

5. The connection terminal according to claim 1, wherein
the recesses are each formed such that a width of the recess in a direction parallel to the reference line becomes larger from a side of the reference line toward the outer edge portion of the joint surface.

6. The connection terminal according to claim 1, wherein
a plated layer having wettability to the brazing material is formed on a surface of the recesses.

7. A circuit component comprising:
the connection terminal according to claim 1; and
a substrate having an element arrangement surface serving as the joint target surface for arrangement of a circuit element, wherein:
the connection terminal is joined in a joint region set on the element arrangement surface; and
the joint region has a margin region in which the circuit element or the joint portion is not to be disposed and which is provided on an outer side of the joint surface along a reference direction which is a direction parallel to the reference line.
